(19) United States
(12) Patent Application Publication
(10) Pub. No.: US 2025/0282516 A1
(43) Pub. Date: Sep. 11, 2025

(54) SYSTEMS AND METHODS FOR PRINTING AND APPLYING LABELS

(71) Applicant: DMT Solutions Global Corporation, Danbury, CT (US)

(72) Inventors: David P. Chastain, New Milford, CT (US); John Robert Masotta, Newtown, CT (US); Mike Henderson, Danbury, CT (US); Joshua Salvator, Danbury, CT (US); Anthony E. Yap, Palmyra, PA (US); David W. Purcell, Danbury, CT (US); Jason Hartbert, Danbury, CT (US)

(21) Appl. No.: 19/075,578

(22) Filed: Mar. 10, 2025

Related U.S. Application Data
(60) Provisional application No. 63/562,819, filed on Mar. 8, 2024.

(51) Int. Cl. B65C 9/40; B65C 9/02; B65C 9/26; B65C 9/46

(52) U.S. Cl. CPC B65C 9/40; B65C 9/02; B65C 9/26; B65C 9/46; B65C 2009/401; B65C 2009/408

(57) ABSTRACT

The present invention provides systems and methods of applying labels to shipping items, such as parcels, packages, or envelopes, in an automated fashion while the shipping items move along a conveyor. The systems and methods of the present invention include use of a uniquely designed label printing and applicator assembly having multi-axis label application capabilities, specifically the ability to move in 4-axes relative to a given shipping item when applying a label thereto. The systems and methods of the present invention further utilize a vision system to collect data of a given shipping item, including, but not limited to, physical dimensions of the item, orientation and skew of the item along the conveyor, and identification of any existing labels and/or indicia on the item. Such data is used by the label printing and applicator assembly to accurately place a given label in desired location on a given shipping item.

### CROSS-REFERENCE TO RELATED APPLICATIONS

This application claims priority to, and the benefit of, U.S. Provisional Application No. 63/562,819, filed Mar. 8, 2024, the content of which is incorporated by reference herein in its entirety.

### TECHNICAL FIELD

The present disclosure relates generally to labeling systems and methods, and, more particularly, to unique systems and methods for automated printing and applying of labels to products, such as shipping items, including parcels, packages, and envelopes, while the shipping items are moved along a conveyor.

### BACKGROUND

Package labeling for warehouse and distribution application operations for shipping items (e.g., parcels, packages, envelopes, and/or other types of shipping items) typically requires labels to be placed on the shipping item. However, current labeling systems and techniques have drawbacks.

Traditional labeling systems are unable to accommodate high volumes of shipping items and the wide range of package sizes, and are further unable to accurately place labels on a given item while avoiding existing labels and/or indicia, thereby leaving operators to deploy multiple lines and/or multiple labeling systems to handle such demand. The result is complicated logistics, wasted space, and additional maintenance.

For example, some traditional labeling systems have a configuration in which a printer and label applicator are in a fixed positioned over conveyor line along which shipping items travel. An applicator pad can then travel (by servo, stepper, or pneumatic drive) down to a given shipping item to be labeled. The printer and label applicator must then return the full distance to the fixed position in order to receive the next label and repeat the label applying process. Such a configuration has drawbacks. For example, in such a configuration, the entire labeler assembly is generally mounted at a height sufficient to accommodate the tallest shipping item to be received on the conveyor, which makes it difficult to load the labels or service the assembly. Furthermore, the overall process can be time-intensive as a result of the applicator pad having to return to the home position after each application of a label (to prepare for the next incoming item), which results in a significant reduction in throughput.

Other labeling systems may be configured to move in multiple axes, such as a movement in the x-axis and y-axis, thereby improving the ability to apply labels in a desired location of a given shipping item. However, such systems are still limited in their ability to accurately apply labels in a cost-efficient and high-throughput manner.

More specifically, current labeling systems generally require aligners to be placed in the designs as they have no ability to adjust the label to match the skew of the package. Furthermore, current labeling systems are not configured to identify existing labels or indicia on a given item and determine whether such existing labels or indicia are essential and must be preserved (i.e., not covered) when applying a new label to the shipping item. Accordingly, current labeling systems may end up covering a preexisting label or indicia that is still required to be visible. Additionally, current labeling system are not configured to identify existing labels or indicia on a given item and determine that such existing labels or indicia are not essential and in fact must be covered with a new label. Furthermore, current labeling systems lack the ability, when performing label-on-label for return logistics, to take into account avoiding applying the new label over a tape seam of the shipping item.

### SUMMARY

The present invention addresses drawbacks of current labeling systems and techniques by providing systems and methods of providing autonomous application of labels to a plurality of items transported along a conveyor.

More specifically, the systems and methods of the present invention utilize a uniquely designed label printing and applicator assembly having multi-axis label application capabilities, specifically the ability to move in 4 axes (x-, y-, z-, and c-axis) relative to a given shipping item when applying a label thereto. The systems and methods of the present invention further utilize a vision system to collect data of a given shipping item, including, but not limited to, physical dimensions of the item, orientation and skew of the item along the conveyor, and identification of any existing labels and/or indicia on the item, among other properties. Such data is used by the label printing and applicator assembly to accurately place a given label in desired location on a given shipping item.

The label printing and applicator assembly generally includes a frame positioned relative to a conveyor along which a plurality of shipping items may travel. In particular, the assembly may generally include a printer for printing or encoding data on one or more of a plurality of labels and an applicator for applying the printed one or more of the plurality of labels to a desired portion on a corresponding one of the plurality of shipping items traveling along the conveyor. The assembly further includes one or more motors configured to move the applicator in at least one of an X-axis, Y-axis, Z-axis direction relative to the conveyor and the corresponding one of the plurality of shipping items, and rotate the applicator about a C-axis relative to the Z-axis direction.

The system may further include a controller configured to communicate and exchange data with the label printing and applicator assembly over a network. The controller includes a hardware processor coupled to non-transitory, computer-readable memory containing instructions executable by the processor to cause the controller to carry out various functions in controlling operation of the label printing and applicator assembly. In particular, the controller is configured to receive and process data from a vision system, the data comprising at least one of physical dimensions of the corresponding one of the plurality of shipping items, orientation and skew of the corresponding one of the plurality of shipping items along the conveyor, and identification of any preexisting labels and/or indicia on the corresponding one of the plurality of shipping items. In turn, the controller is configured to autonomously control movement of the applicator in one or more of the X-axis, Y-axis, Z-axis, and C-axis directions based, at least in part, on the processing of data to cause the applicator to apply the printed one or more of the plurality of labels to the desired portion on the corresponding one of the plurality of shipping items.

The X-axis direction corresponds to a direction along an xy-plane is substantially parallel to the direction along which the plurality of shipping items travel along the conveyor and the Y-axis direction corresponds to a direction along an xy-plane that is substantially perpendicular to the direction along which the plurality of shipping items travel along the conveyor. The Z-axis direction corresponds to a direction that is substantially perpendicular to the direction along which the plurality of shipping items travel along the conveyor and lies along an out of plane axis relative to the xy-plane.

The vision system generally includes comprises a camera configured to capture one or more images of each of the plurality of shipping items traveling along the conveyor prior to traveling to the label printing and applicator assembly. Accordingly, based on processing of the one or more images, at least one of the physical dimensions of the corresponding one of the plurality of shipping items, the orientation and skew of the corresponding one of the plurality of shipping items along the conveyor, and the identification of any preexisting labels and/or indicia on the corresponding one of the plurality of shipping items is calculated. Furthermore, a determination is made as to whether an identified preexisting label and/or indicia is required to remain visible or can be covered by the printed one or more of the plurality of labels. For example, certain labels or indicia are required (due to shipping laws, rules, and/or regulations) to remain visible.

The controller is configured to determine placement coordinates of the printed one or more of the plurality of labels on the corresponding one of the plurality of shipping items based, at least in part, on the data received from the vision system. For example, in one embodiment, the placement coordinates are positioned outside of an area of the corresponding one of the plurality of shipping items in which the identified preexisting label is placed and/or the identified preexisting indicia is printed such that the identified preexisting label and/or indicia remain visible after the printed one or more of the plurality of labels is applied. In another embodiment, the placement coordinates are positioned within of an area of the corresponding one of the plurality of shipping items in which the identified preexisting label is placed and/or the identified preexisting indicia is printed such that the printed one or more of the plurality of labels is applied over and covers the identified preexisting labels and/or indicia.

The system is further able to identify the presence/location of one or more tape seams on each of the plurality of shipping items based on the processing of images. In turn, the controller is configured to determine placement coordinates of the printed one or more of the plurality of labels on the corresponding one of the plurality of shipping items based, at least in part, on the data received from the vision system, such that the placement coordinates are positioned outside of an area of the corresponding one of the plurality of shipping items in which one or more identified tape seams lie such that the one or more identified tape seams remain visible and uncovered after the printed one or more of the plurality of labels is applied.

Accordingly, the unique systems and methods of the present invention address the drawbacks of current labeling systems by providing up to a 4-axis direction of motion and incorporating the advantages of a vision system when applying a given printed label, which allows for on-the-fly adjustment for each shipping item during application of given printed label to account for various sizes and orientations of shipping items when traveling along the conveyor, as well as determining whether there are any preexisting labels and/or indicia on a given shipping item that need to either remain visible or should be covered by a given printed label, as well as avoidance of applying printed labels over tape seams of a shipping item. Therefore, the systems and methods of the present invention are designed to specifically to handle high-volume warehouse and distribution operations by effortlessly handling a wide variety of product sizes and materials, thereby maximizing uptime and boosting facility throughput. The systems and methods are further compatible with linerless or die-cut labels and can integrate seamlessly with new or existing automation systems. The systems and methods easily connect with industry-standard cameras, scanners, and scales, as well as other external systems, to retrieve real-time label data, support high-speed tracking and data transfer, and manage exception handling efficiently and with case.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram schematic of an exemplary system for autonomous application of labels to a plurality of items transported along a conveyor, according to one embodiment of the present disclosure.

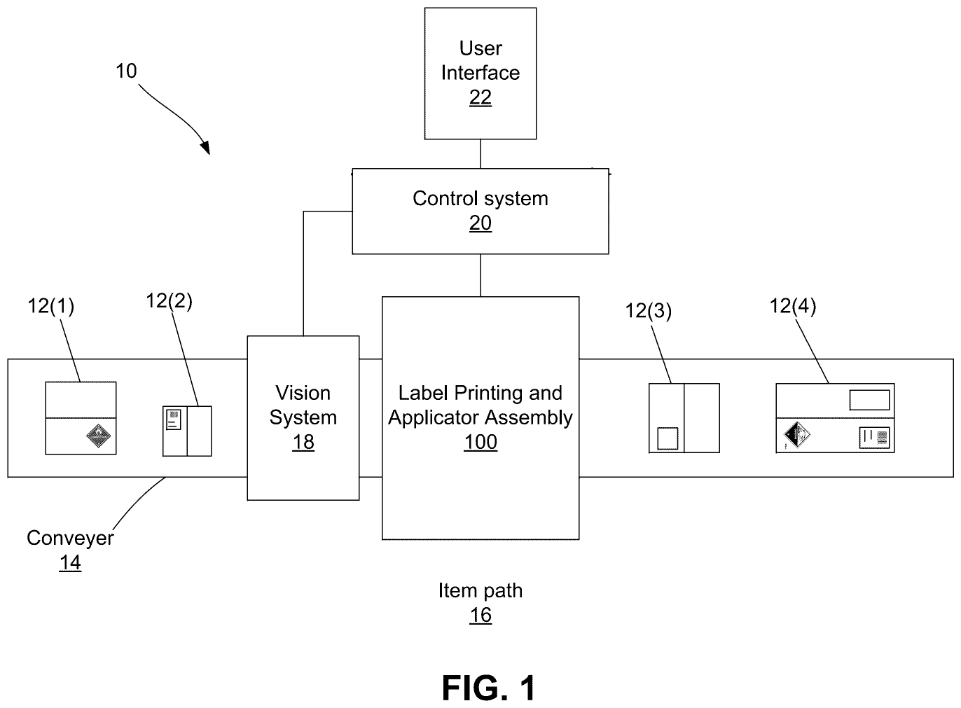

FIG. 2 is a perspective view of one embodiment of a label printing and applicator assembly consistent with the present disclosure.

FIG. 3 is a top view of the label printing and applicator assembly of FIG. 2.

FIG. 4 is a side view of the label printing and applicator assembly of FIG. 2.

FIG. 5 is an alternative side view of the label printing and applicator assembly of FIG. 2.

FIG. 6 is an enlarged side view illustrating the printer-applicator device of the label printing and applicator assembly of FIG. 5.

FIGS. 7 and 8 are images illustrating the ability of the system of the present disclosure to accurately place printed labels on desired portions of parcels to thereby avoid tape seams and/or preexisting labels and/or indicia that should remain uncovered.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

By way of overview, the present invention is directed to unique systems and methods for automated printing and applying of labels to products, such as shipping items, including parcels, packages, and envelopes, while the shipping items are moved along a conveyor. The system 10 may be useful for a warehouse, consolidator, and/or distribution center. However, it should be noted that there are numerous applications for the system 10 which include, but are not limited to warehouse stocking, distribution center-retail or wholesale, order fulfillment, hub sorting operations for delivery services, etc.

In some embodiments, the system 10 may generally include conveyor transport system including a conveyor 14 upon which shipping items 12 travel. The shipping items 12 may include, for example, a parcel, a package, a box, a flat envelope, a polybag, a sack, etc., of various sizes and shapes that is consistent with the system 10. In some aspects, the shipping items 12 to be labeled enter the processing line from the left on the conveyor 14 and travel to the right, as indicated by the directional arrow 16.

The system 10 includes a label printing and applicator assembly 100 positioned relative to the conveyor 14. The assembly 100 is configured to print and apply one or more labels to a given item 12, as will be described in greater detail herein. The system 10 further includes a vision system 18, control system (or controller) 20, and user interface 22 (allowing an operator to interact with one or more of the system 10 components) operably coupled to one another and the label printing and applicator assembly 100. It should be noted that, in addition to the vision system 18, the system 10 may include other sensors or the like for capturing data related to a given item 12 prior to, during, and after the given 12 passes through the label printing and applicator assembly 100. For example, the system 10 may include various sensors (and sensor systems), such as those described in described in in co-owned U.S. Pat. Nos. 9,352,872; 9,809,343; 9,926,096; 10,450,099; and 10,569,922, the content of each of which is incorporated by reference herein in its entirety.

The control system 20 is configured to communicate and exchange data with the label printing and applicator assembly 100 over a network. For example, the network may include a wired or wireless connection. The control system 20 may include a hardware processor coupled to non-transitory, computer-readable memory containing instructions executable by the processor to cause the control system 20 to carry out various functions. For example, the control system 20 may generally be configured to receive and process data from the vision system 18, the data related to characteristics of a given one of the plurality of shipping items 12 traveling along the conveyor 14 and to pass along to the label printing and applicator assembly 100.

For example, such data may include, but is not limited to, physical dimensions of each of the plurality of shipping items 12 (i.e., length, width, height), orientation and skew of each of the plurality of shipping items 12 along the conveyor 14, identification of any preexisting labels and/or indicia on each of the plurality of shipping items 12, and identification of one or more tape seams on each of the plurality of shipping items 12. The vision system 18 may include a camera, for example, configured to capture one or more images of each of the plurality of shipping items 12 traveling along the conveyor prior to traveling to the label printing and applicator assembly 100. The vision system 18 may further include hardware for running software including one or more algorithms (i.e., image analysis and recognition algorithms) for the determination of the one or more characteristics (i.e., physical dimension calculation, orientation and skew calculation, identification of preexisting labels and/or indicia and associated requirements to be covered or remain visible, and identification of tape seams).

Upon receiving and processing the data from the vision system 18, the control system 20 is configured to autonomously control operation of the label printing and applicator assembly 100. As described in greater detail herein, the label printing and applicator assembly 100 includes a printer for printing or encoding data on one or more of a plurality of labels and an applicator for applying the printed one or more of the plurality of labels to a desired portion on a corresponding one of the plurality of shipping items traveling along the conveyor. The assembly 100 further includes one or more motors (i.e., servo motors or the like) configured to move the applicator in at least one of an X-axis, Y-axis, Z-axis direction relative to the conveyor and the corresponding one of the plurality of shipping items, and rotate the applicator about a C-axis relative to the Z-axis direction.

Accordingly, the control system 20 is configured to autonomously control movement of the applicator in one or more of the X-axis, Y-axis, Z-axis, and C-axis directions based, at least in part, on the processing of data to cause the applicator to apply the printed one or more of the plurality of labels to the desired portion on the corresponding one of the plurality of shipping items.

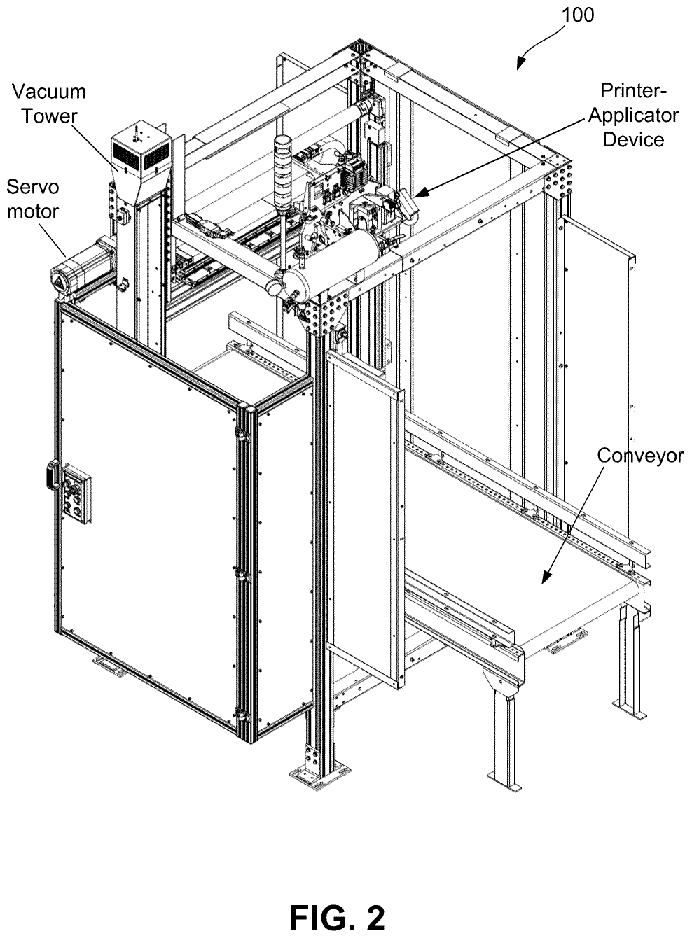

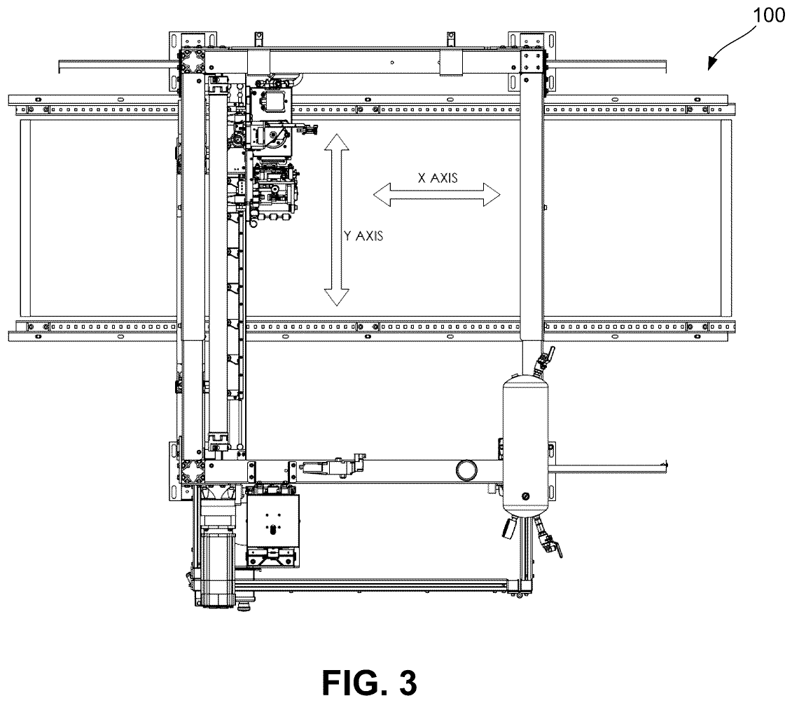

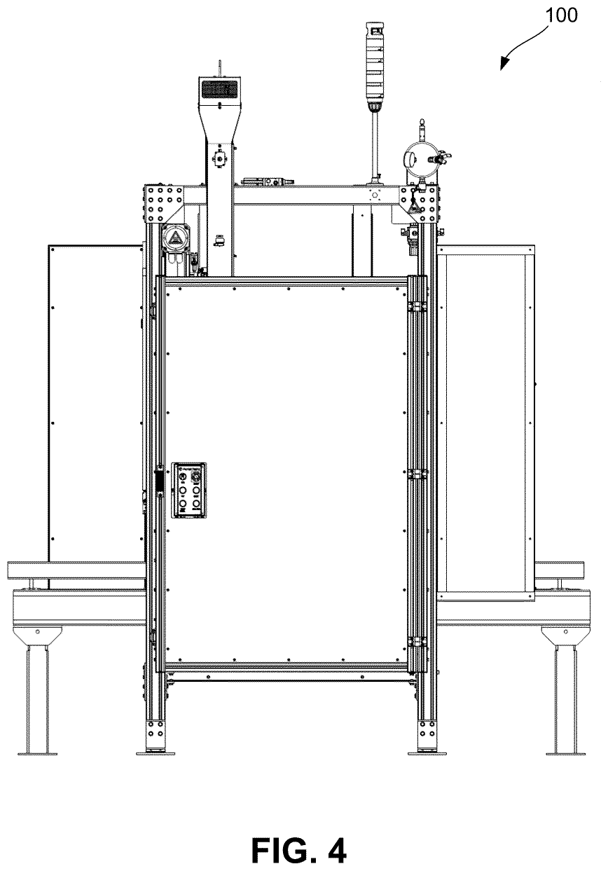

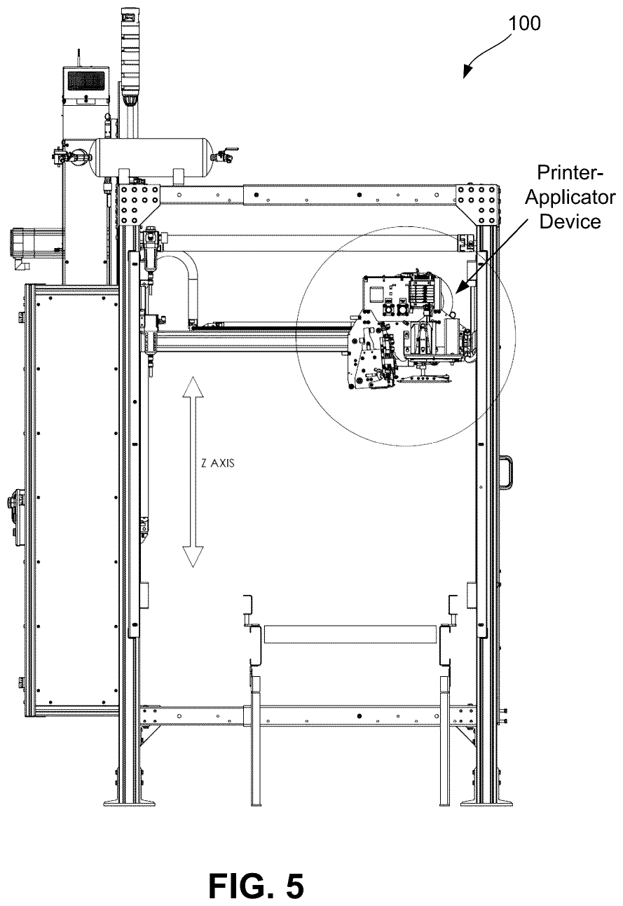

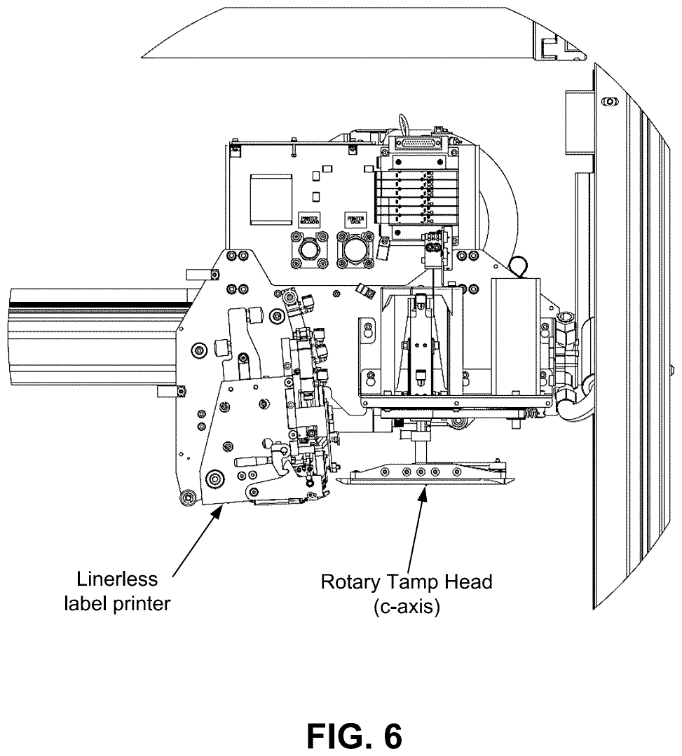

FIG. 2 is a perspective view of one embodiment of a label printing and applicator assembly 100 consistent with the present disclosure. FIGS. 3, 4, and 5 are top and side views, respectively, of the label printing and applicator assembly 100. FIG. 6 is an enlarged side view illustrating the printer-applicator device of the label printing and applicator assembly 100.

As show, the X-axis direction corresponds to a direction along an xy-plane is substantially parallel to the direction along which the plurality of shipping items travel along the conveyor. The Y-axis direction corresponds to a direction along an xy-plane that is substantially perpendicular to the direction along which the plurality of shipping items travel along the conveyor. The Z-axis direction corresponds to a direction that is substantially perpendicular to the direction along which the plurality of shipping items travel along the conveyor and lies along an out of plane axis relative to the xy-plane. The applicator is further configured to rotate about a C-axis relative to the Z-axis direction. Accordingly, to move in 4 axes (x-, y-, z-, and c-axis) relative to a given shipping item 12 when applying a label thereto.

As previously described, the control system 20 is configured to determine placement coordinates of a printed label on a corresponding one of the plurality of shipping items 12 based, at least in part, on the data received from the vision system 18.

For example, various characteristics of a given one of the shipping items 12 can be calculated based on data captured via the vision system 18, including image data. Such characteristics may include the physical dimensions, as well as the orientation and skew of a given shipping item 12 traveling along the conveyor 14 prior to traveling to the label printing and applicator assembly 100. Additional characteristics may include the identification of any preexisting labels and/or indicia on a given shipping item 12, which may further include a determination is made as to whether an identified preexisting label and/or indicia is required to remain visible or can be covered by the printed one or more of the plurality of labels. For example, certain labels or indicia are required (due to shipping laws, rules, and/or regulations) to remain visible. Furthermore, the system is further able to identify the presence/location of one or more tape seams on each of the plurality of shipping items based on the processing of images.

In turn, the controller 20 is configured to determine, on-the-fly, placement coordinates of a printed label on a corresponding shipping item based, at least in part, on the data received from the vision system 18 and the various attributes of a given item 12.

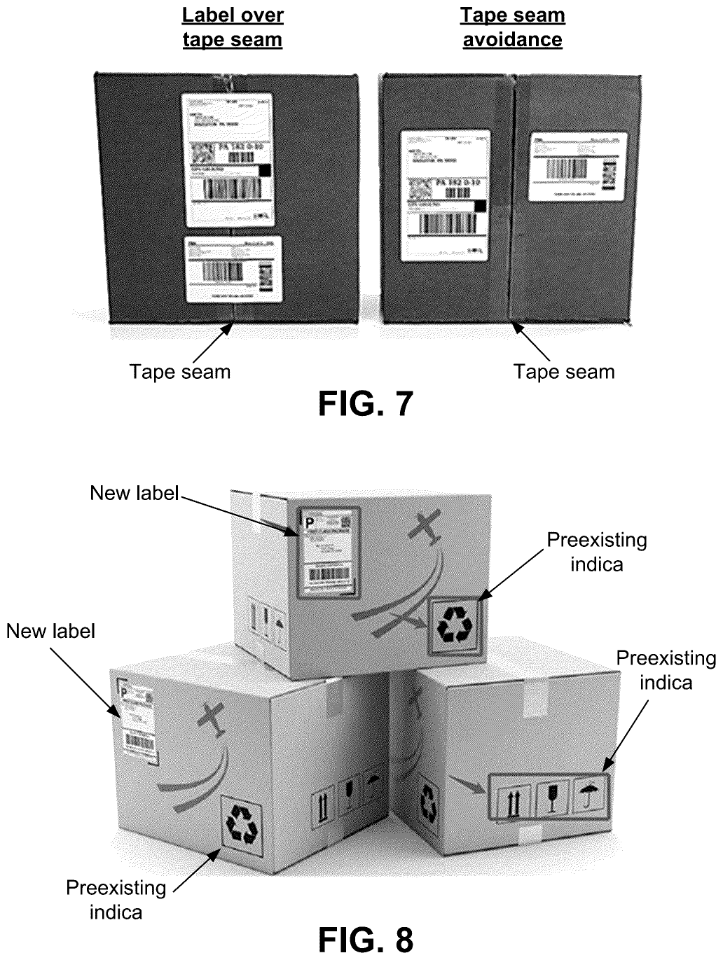

FIGS. 7 and 8 are images illustrating the ability of the system of the present disclosure to accurately place printed labels on desired portions of parcels to thereby avoid tape seams and/or preexisting labels and/or indicia that should remain uncovered. For example, the placement coordinates are positioned outside of an area of the corresponding one of the plurality of shipping items in which one or more identified tape seams lie such that the one or more identified tape seams remain visible and uncovered after the printed one or more of the plurality of labels is applied. In another example, as shown in FIG. 8, the placement coordinates are positioned outside of an area of the corresponding one of the plurality of shipping items in which the identified preexisting label is placed and/or the identified preexisting indicia is printed such that the identified preexisting label and/or indicia remain visible after the printed one or more of the plurality of labels is applied.

Accordingly, the unique systems and methods of the present invention address the drawbacks of current labeling systems by providing up to a 4-axis direction of motion and incorporating the advantages of a vision system when applying a given printed label, which allows for on-the-fly adjustment for each shipping item during application of given printed label to account for various sizes and orientations of shipping items when traveling along the conveyor, as well as determining whether there are any preexisting labels and/or indicia on a given shipping item that need to either remain visible or should be covered by a given printed label, as well as avoidance of applying printed labels over tape seams of a shipping item. Therefore, the systems and methods of the present invention are designed to specifically to handle high-volume warehouse and distribution operations by effortlessly handling a wide variety of product sizes and materials, thereby maximizing uptime and boosting facility throughput. The systems and methods are further compatible with linerless or die-cut labels and can integrate seamlessly with new or existing automation systems. The systems and methods easily connect with industry-standard cameras, scanners, and scales, as well as other external systems, to retrieve real-time label data, support high-speed tracking and data transfer, and manage exception handling efficiently and with case.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system for providing autonomous application of labels to a plurality of items transported along a conveyor, the system comprising:
a label printing and applicator assembly positioned relative to the conveyor, the assembly comprising:
a printer for printing or encoding data on one or more of a plurality of labels;
an applicator for applying the printed one or more of the plurality of labels to a desired portion on a corresponding one of the plurality of shipping items traveling along the conveyor; and
one or more motors configured to move the applicator in at least one of an X-axis, Y-axis, and Z-axis direction relative to the conveyor and the corresponding one of the plurality of shipping items, and rotate the applicator about a C-axis relative to the Z-axis direction; and
a controller configured to communicate and exchange data with the label printing and applicator assembly over a network, the controller comprising a hardware processor coupled to non-transitory, computer-readable memory containing instructions executable by the processor to cause the controller to:
receive and process data from a vision system, the data comprising at least one of physical dimensions of the corresponding one of the plurality of shipping items, orientation and skew of the corresponding one of the plurality of shipping items along the conveyor, and identification of any preexisting labels and/or indicia on the corresponding one of the plurality of shipping items; and
autonomously control movement of the applicator in one or more of the X-axis, Y-axis, Z-axis, and C-axis directions based, at least in part, on the processing of data to cause the applicator to apply the printed one or more of the plurality of labels to the desired portion on the corresponding one of the plurality of shipping items.

2. The system of claim 1, wherein the X-axis direction corresponds to a direction along an xy-plane is substantially parallel to the direction along which the plurality of shipping items travel along the conveyor.

3. The system of claim 1, wherein the Y-axis direction corresponds to a direction along an xy-plane that is substantially perpendicular to the direction along which the plurality of shipping items travel along the conveyor.

4. The system of claim 1, wherein the Z-axis direction corresponds to a direction that is substantially perpendicular to the direction along which the plurality of shipping items travel along the conveyor and lies along an out of plane axis relative to the xy-plane.

5. The system of claim 1, wherein the vision system comprises a camera configured to capture one or more images of each of the plurality of shipping items traveling along the conveyor prior to traveling to the label printing and applicator assembly.

6. The system of claim 5, wherein, based on processing of the one or more images, at least one of the physical dimensions of the corresponding one of the plurality of shipping items, the orientation and skew of the corresponding one of the plurality of shipping items along the conveyor, and the identification of any preexisting labels and/or indicia on the corresponding one of the plurality of shipping items is calculated.

7. The system of claim 6, wherein a determination is made as to whether an identified preexisting label and/or indicia is required to remain visible or can be covered by the printed one or more of the plurality of labels.

8. The system of claim 7, wherein the controller is configured to determine placement coordinates of the printed one or more of the plurality of labels on the corresponding one of the plurality of shipping items based, at least in part, on the data received from the vision system.

9. The system of claim 8, wherein the placement coordinates are positioned outside of an area of the corresponding one of the plurality of shipping items in which the identified preexisting label is placed and/or the identified preexisting indicia is printed such that the identified preexisting label and/or indicia remain visible after the printed one or more of the plurality of labels is applied.

10. The system of claim 9, wherein the placement coordinates are positioned within of an area of the corresponding one of the plurality of shipping items in which the identified preexisting label is placed and/or the identified preexisting indicia is printed such that the printed one or more of the plurality of labels is applied over and covers the identified preexisting labels and/or indicia.

11. The system of claim 6, wherein, based on processing of the one or more images, one or more tape seams on each of the plurality of shipping items is identified.

12. The system of claim 11, wherein the controller is configured to determine placement coordinates of the printed one or more of the plurality of labels on the corresponding one of the plurality of shipping items based, at least in part, on the data received from the vision system.

13. The system of claim 11, wherein the placement coordinates are positioned outside of an area of the corresponding one of the plurality of shipping items in which one or more identified tape seams lie such that the one or more identified tape seams remain visible and uncovered after the printed one or more of the plurality of labels is applied.

14. The system of claim 1, wherein the label printing and applicator assembly further comprises a label assembly for feeding the plurality of labels to the printer.

15. The system of claim 14, wherein the label assembly comprises a linerless labels or die-cut labels.

16. The system of claim 1, wherein the plurality of shipping items comprises at least one of parcels, packages, and envelopes.
